(19) United States
(12) Patent Application Publication
(10) Pub. No.: US 2017/0178525 A1
(43) Pub. Date: Jun. 22, 2017

(54) ONLINE EDUCATION COURSE NAVIGATION SYSTEM

(71) Applicant: COURSERA, INC., Mountain View, CA (US)

(72) Inventor: Grace KWAN, Mountain View, CA (US)

(21) Appl. No.: 15/381,885

(22) Filed: Dec. 16, 2016

Related U.S. Application Data
(60) Provisional application No. 62/269,906, filed on Dec. 18, 2015.

(51) Int. Cl. G09B 5/06; G09B 7/00; G06F 3/0483; G09B 5/12; G06F 9/44; G06F 3/0482

(52) U.S. Cl. CPC G09B 5/06; G06F 9/4446; G06F 3/0482; G06F 3/0483; G09B 5/12; G09B 7/00; H04L 67/02

(57) ABSTRACT

A method includes presenting an online education course on a first communication device. The online education course presentation includes a hierarchical schema of items grouped in one or more hierarchy levels and presented as web pages or item views on the first communication device. The method further includes integrating a navigation system with a current item view of the online education course presentation, the navigation system including at least one UI element that provides visual information about the current item view and its location in the hierarchical schema of the online education course, and at least one UI element that leads to a different item view from the current item view of the online education course presentation.

### CROSS-REFERENCE TO RELATED APPLICATION

This application is a non-provisional of, and claims priority to, U.S. Patent Application No. 62/269,906, filed on Dec. 18, 2015, entitled “ONLINE EDUCATION COURSE NAVIGATION SYSTEM,” which is incorporated by reference herein in its entirety.

### BACKGROUND

Students (learners) are increasingly engaging in online education activities. Students taking online education courses may do so for various reasons (e.g., professional reasons, lifelong interests in learning, etc.), and invest significant effort into completing coursework (e.g., assignments, exams, etc.) in order to complete a course. An online education course may be provided to students over network connections or the Internet by an education course provider. For example, an online course provider may have access to, or create, course materials or resources for an online education course on a cloud computing platform. The online course provider may serve the course materials to the students as web pages on network or Internet-connected client communication devices.

Entire education courses with structured programs (e.g., including a series of lectures, demonstrations, quizzes and tests, etc.) can be made available online to students from the cloud computing platform. The students may receive the online education course content (e.g., video) on a computing device (e.g., desktop, laptop, tablets, a mobile phone, a smartphone, a radio transceiver, a telephone, a mobile computing device, etc.), which may have a variety of technical capabilities (e.g., internet connections, input/output devices, audio or video capabilities, display size, etc.). Furthermore, students may participate in such courses while in any of a variety of study environments or circumstances (e.g., sitting in a room, travelling in a bus, or walking).

Consideration is now given to facilitating a student's navigation of the course materials or resources of an online education course served by a cloud computing platform.

### SUMMARY

An online education course may have a hierarchical schema of items (e.g., learning materials) grouped in one or more hierarchy levels. An example sequence of hierarchy levels may be week/lessons/items. Another example sequence of hierarchy levels may be chapter/section/subsection/items. The items are presented as web pages or item views in an online education presentation on a client device to a learner.

In a general aspect, a system for navigating the online education course presentation on the client device includes one or more processors and one or memories storing computer-readable instructions. The instructions when executed by the one or more processors display, to a learner, a plurality of user interface (UI) elements integrated with a current item view of the online education course presentation. The plurality of UI elements include at least one UI element that provides visual information about the current item view and its location in the hierarchical schema of the online education course, and at least one UI element that leads to a different item view from the current item view of the online education course presentation.

In an aspect, the at least one UI element that provides visual information about the current item view and its location in the hierarchical schema of the online education course is an UI element that shows an analog measure of progress represented by the current item view in the online education course.

In an aspect, the at least one UI element that provides visual information about the current item view and its location in the hierarchical schema of the online education course is a breadcrumb UI element that shows a URL trail leading to the current item view in the hierarchical schema of the online education course.

In an aspect, the at least one UI element that leads to different item view from the current item view of the online education course presentation is an UI element that leads to an item view which is immediately adjacent to the current item view in the hierarchical schema of the online education course.

In an aspect, the at least one UI element that leads to different item view from the current item view of the online education course presentation is an UI element that leads, in a single click operation, to an item view which is not immediately adjacent to the current item view in the hierarchical schema of the online education course.

In an aspect, the online education course includes an overview page for a hierarchy level in the hierarchical schema of the online education course, and the at least one UI element that leads to a different item view from the current item view of the online education course presentation is an UI element that leads to the overview page for the hierarchy level in the hierarchical schema of the online education course. The overview page for the hierarchy level in the hierarchical schema of the online education course provides contextual information for the current item view of the online education course presentation.

In a further aspect, the plurality of user interface elements integrated with a current item view of the online education course presentation include one or more UI elements disposed in an informational panel co-displayed with the current item view.

In an aspect, the one or more UI elements disposed in the informational panel co-displayed with the current item view include one or more UI elements that provide contextual information for the current item view of the online education course presentation at one or more of the hierarchy levels in the hierarchical schema of the online education course.

In an aspect, the online education course includes an overview page for an hierarchy level in the hierarchical schema of the online education course, and the one or more UI elements disposed in the informational panel co-displayed with the current item view include an UI element that leads to the overview page for the hierarchy level in the hierarchical schema of the online education course.

In an aspect, the current item view relates to an item in one hierarchy level in the hierarchical schema of the online education course, and the one or more UI elements disposed in the informational panel co-displayed with the current item view include an UI element that leads, in a single click operation, to an item view related to an item in another hierarchy level in the hierarchical schema of the online education course.

In an aspect, the current item view relates to an item in one hierarchy level in the hierarchical schema of the online education course, and the one or more UI elements disposed in the informational panel co-displayed with the current item view include an UI element that leads, in a single click operation, to an item view related to another item in the same hierarchy level as the current item view.

In an aspect, the one or more UI elements disposed in the informational panel co-displayed with the current item view include one or more UI elements that provide completion or progress information for the one or more hierarchy levels in the hierarchical schema of the online education course.

In an aspect, the informational panel co-displayed with the current item view includes a user-activable UI element which when activated collapses or detaches the informational panel from the current item view.

In another aspect, the current item view includes an UI element leading to a quiz on materials in the online education course, and the at least one UI element that leads to a different item view from the current item view of the online education course presentation is an UI element that leads to an item view related to review materials in the online education course for the quiz.

The details of one or more implementations are set forth in the accompanying drawings and the description below. Further features of the disclosed subject matter, its nature and various advantages will be more apparent from the accompanying drawings, the following detailed description, and the appended claims.

### BRIEF DESCRIPTION OF THE DRAWINGS

The accompanying drawings, in which like numerals indicate like components, illustrate embodiments of the disclosed subject matter.

FIG. 1 illustrates an embodiment of an example cloud computing environment in which online education courses are presented to students on client devices, in accordance with the principles of the present disclosure.

FIGS. 2-5 are example screen shots of example web page or item views of online education courses, in accordance with the principles of the present disclosure.

FIG. 6 is a flow chart illustrating an example method for presenting an online education course and a navigation system for navigating from a currently displayed individual item to another non-adjacent individual item in a current lesson by a single click operation, in accordance with the principles of the present disclosure.

### DETAILED DESCRIPTION

Systems and methods for facilitating a student's navigation of course materials or resources of an online education course served by a cloud computing platform are described herein. The systems and methods involve a navigation system that is integrated with web pages of the online education course served by a cloud computing platform, in accordance with the principles of the present disclosure. The navigation system may include user interface (UI) elements that allow a student to navigate to different web pages or item views from a current web page or item view of an online education course presentation.

Reference will now be made in detail to embodiments of the disclosed subject matter, examples of which are illustrated in the accompanying drawings

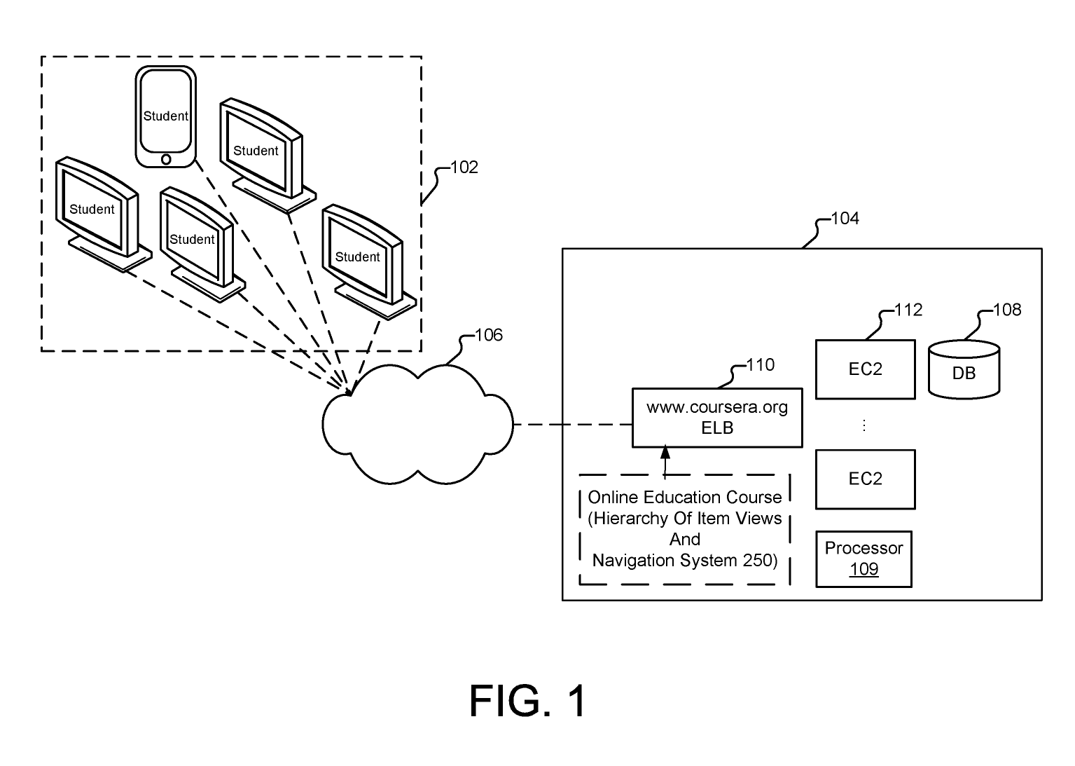

In example implementations, an online course provider's online education platform may support massive open online courses (“MOOCs”), in which tens of thousands (or other applicable numbers) of students (students) can enroll, and participate, in the same course at the same time. FIG. 1 shows an example cloud computing arrangement including an online education platform 104, which may be used by the online course provider to provide online education course materials and resources to students on client devices 102 (e.g., laptop computers, desktop computers, mobile devices, smart phones, etc.) Students, using client devices 102, can connect to platform 104 via one or more network(s) 106, which are represented in FIG. 1, for example, as a single network cloud. The students can sign up for an account with the platform, which, for example, can be linked to the student's email address. Students may interact with platform 104 to enroll in courses and receive instructions, such as through video lectures and handouts. As part of taking a course, students can submit work, such as surveys, quizzes, exams, homework, assignments, etc. Examples of client devices 102 include desktop computers, portable computers, tablets, smartphones, and any other appropriate electronic devices configurable to communicate with platform 104 in accordance with the techniques described herein.

In example cloud computing implementations, the students' client devices attempting to access online education course materials may communicate with an Amazon Elastic Loadbalancer (ELB). In the embodiment shown in FIG. 1, when client devices (e.g., any of devices 102) attempt to access course materials or resources provided by platform 104, they may initially communicate with a load balancer (e.g., an Amazon Elastic Loadbalancer (ELB)) 110 because the number of devices attempting to access the course material may be too large for a single server to service. The load balancer 110 distributes traffic across multiple servers instances (e.g., Amazon EC2 instances) 112 that serve content to the client devices (e.g., via web frontends, native applications installed on mobile devices, etc.). In some embodiments, databases such as database 108 are used to store information such as account information, personal information, profile information, collected enrollment/registration and authentication information (e.g., keystroke biometrics, webcam headshots, webcam capture of photo ID documentation), credentials (e.g., statements, verified certificates, certifiable course records, etc.), or any other appropriate information. The storage of the data can also be divided across multiple storage locations (e.g., using Amazon S3). In some embodiments each course is associated with its own database, which is used to store course content (e.g., submitted by instructors via an interface provided by instance 112), student information, student submissions, authentication information submitted with the student submissions, etc.

Platform 104 may be implemented using a scalable, elastic architecture. When platform 104 is referred to as performing a task, such as storing data or processing data, it is to be understood that one or more sub-components of platform 104 (whether individually or in cooperation with third party components) may cooperate to perform that task. Further, certain tasks may be distributed such that a given task is accomplished by multiple instances of a component depicted in FIG. 1 as a single component. In some embodiments, online education platform 104 can include a single device, such as a standard commercially available server (e.g., with a plurality of multi-core processors, 16+ Gigabytes of RAM, and one or more Gigabit network interface adapters) and can run a server-class operating system (e.g., Linux). Alternately or additionally, platform 104 may include other processors (e.g., semiconductor-based processor 109), which may be coupled to database 108 for intake and processing of course-related materials. The server's multi-core processors and or processor 109 may host a navigation system (e.g., navigation system 250) included in an online education course presentation. Navigation system 250 may allow a student to navigate to different web pages or item views from a current web page or item view in the online education course presentation.

From one perspective, an example online education course may be viewed as an ordered collection of online education items (e.g., web pages, audio content, video content, graphical content, forms, quizzes, surveys, etc.). The online education items can be arranged in a hierarchical structure that may be indexed to facilitate navigation of the items by the user.

An example online education course, which may be intended to be taken by a student over a period of time (e.g., weeks), may have a hierarchical schema, with the syllabus or course content organized (e.g., by a course instructor or educator) or structured as fragments or portions of the course content as items grouped in a hierarchy of levels. The course content of the example online education course may be organized in terms of one of more time periods in which the student is expected to consume the content of the course. For example, the course may be organized by week. Each week may include multiple sections or lessons of the course. Each lesson may include one or more items (e.g., textual reading segments, audio visual lecture segments, interactive question and answer sessions, and student participation events such as submission of student coursework related to quizzes, tests, reports, etc.). The lessons or items of the course content may be presented, for example, as a series of web pages, on client devices.

For convenience of description herein, each web page or item of the course content presented or displayed on the student's client device may be referred to herein as an “item view.”

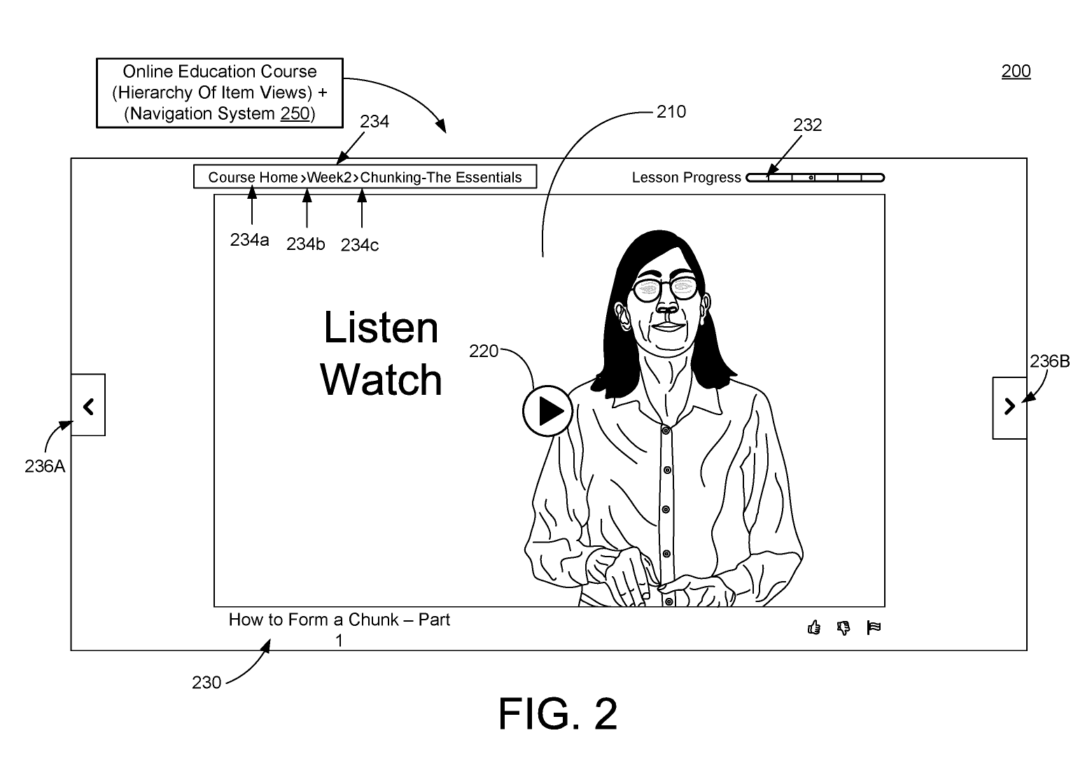

FIG. 2 is a screen shot of an example web page or item view 200 of an example online education course. Item view 200 may include, for example, a lecture video item “How to Form a Chunk—part 1” (e.g., item 210), which the student can listen to or watch by activating, for example, a “play video” button 220 included in item 210.

The course content (e.g., lessons and items) web pages may be intended (e.g., by the course instructor or educator) to be presented to a student sequentially or serially on a time line, for example, in week-by-week segments. However, since the course content is stored in the cloud computing environment, the course content can be replayed or served item-by-item to the student, for example, on demand. The student may want to peruse the course content (e.g., item views) at his or her own pace or in a personally preferred order. For example, the student (who may be at current web page or item view in a week in the course) may want to revisit or review previously presented portions of the course content (e.g., a previously viewed item or lesson) to prepare for an upcoming quiz or exam. Further, the student may want to revisit or review portions of the course content (e.g., a previously viewed item or lesson), for example, to help the student better understand a current item or lesson.

The online education course presentation by the online education course provider may include a navigation system to help the student navigate to different web pages or item views from a current web page or item view in the online education course presentation. The navigation system may include an arrangement of one or more UI elements. The navigation system (e.g., item-level navigation system 250) may be incorporated or rendered in the current web page or item view by the online course provider platform. Item-level navigation system 250 may include informational UI elements, which may provide visual information about the current item view and its location within the hierarchical schema of the education course.

FIG. 2 shows, for example, item view 200 as including one or more informational UI elements of item-level navigation system 250 (e.g., Title 230 “How to Form a Chunk—Part 1”; item-level lesson progress bar 232, which may show an analog measure of progress represented by item view 200 in the lesson of the course; and item-level breadcrumb UI element 234, which may show a URL trail (e.g., link 234a “Course home”>link 234b “Week 2”>link 234c “Chunking—The Essentials”) leading to item view 200 in a course, week and lesson hierarchy of the online education course. The content for a particular week of the course may include a plurality of items intended for the student to digest during that week of the course. The UI elements of navigation system 250 may further include item level navigation UI elements, which may be activated, for example, to move the course presentation from current item view 200 to another item view in the online education course. FIG. 2 shows, for example, item view 200 as including item-level navigation UI elements 236A and 236B (visually represented as backward and forward arrows), which can be user activated to move the course presentation to item views immediately adjacent to item view 200, respectively, in the hierarchical schema of the education course. The items view immediately before and after a presented item view may be part of the content for the week to which the presented item belongs. When a user comes to the last item of a week of a course, clicking on the UI element 236B may cause the first item of the next week of the course to be presented.

It may be expected that with the navigation system shown in FIG. 2, the student wanting to shift from the current item view to another relevant item view (e.g., in a lesson or week) may, for example, have to laboriously click through each intervening item view by using item-level navigation UI element 236A to locate the relevant item view in the lesson or week.

In example course implementations, the course presentation item views may include home or weekly overview pages. For example, the home overview page may provide a course syllabus for the entire course or an overview of the content taught in different blocks (e.g., time periods, such as, weeks) of the course, and the overview page for a week of the course may provide an overview of the content items associated with that week of the course. The student may have to locate the home or weekly overview page, for example, by clicking through each intervening item view by using item-level navigation UI elements 236A or 236B, or by clicking on link 234a “Course home” or link 234b “Week 2” in breadcrumbs UI element 234. While such home or weekly overview pages may reorient students on the course content, for example, in weekly segments, these pages may not provide sufficient course, week or item level context to help the student quickly locate the relevant item view. Even after arriving at a week overview page, the student may have to scroll through the week overview page to identify and click through to enter the relevant item view.

In field studies of item-level navigation systems (e.g., navigation system 250), it was found that an unexpectedly high percentage of students enter a “quiz” item view through the week overview page. This suggests that students use the week overview page to reorient themselves before attempting an assessment (e.g., quizzes or exams). Further, in the studies, it was noted that in navigation system 250, weeks are not prominently referenced in the item views. Weeks are referenced, for example, only in breadcrumbs UI element 234, which is not very prominently displayed. Further, students using item-level navigation UI elements 236A or 236B can accidentally or inadvertently pass over from one week into the next without returning to the current week overview page. It was also noted in the studies that a higher percentage of students than expected used clicks on week breadcrumb 234 in an item view to arrive at the week overview page. This may suggest that the students find the information in the week overview pages is useful, for example, for reorientation, as the students consume item level views. It was also noted that many students may chunk or break their learning sessions using assessments (e.g., quizzes or exams) as break points. A large percentage of students use the week or home overview pages to reorient themselves after the assessment break points.

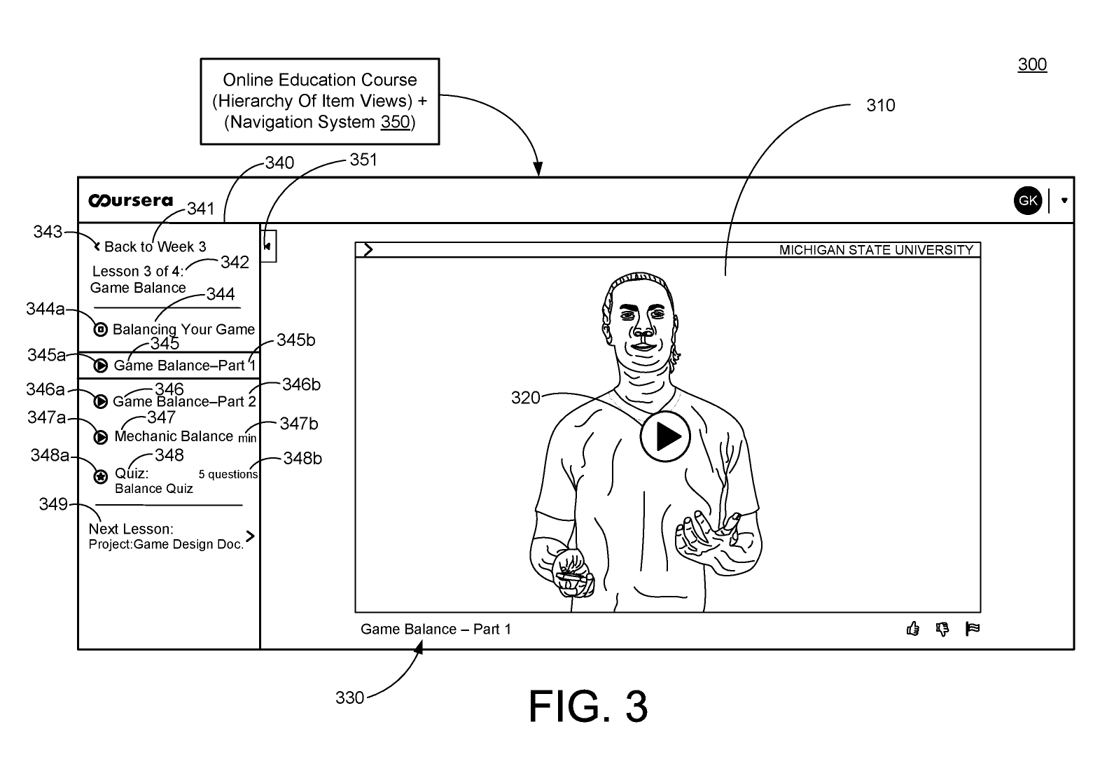

Another navigation system (e.g., navigation system 350, FIG. 3) for an online education course may be configured, for example, with UI elements, which allow students to navigate to other item views in a lesson (e.g., non-adjacent item views) from a current item view with a single click operation (in contrast to navigation system 250, which may require multiple clicks). The UI elements in navigation system 350 may include UI elements that provide week level information and lesson information in the current item view itself. The week level and lesson information may include contextual information for the current item view. Such information may, for example, guide and orient the student on the course content even as the student is at the current item view.

FIG. 3 is a screen shot of an example web page or item view 300 of an example online education course in which UI elements of navigation system 350 are incorporated. Item view 300 may include, for example, a lecture video item “Game balance—part 1” (e.g., item 310), which the student can listen to or watch by activating, for example, a “play video” button 320 included in item 310.

FIG. 3 shows, for example, current item view 300 as including one or more informational UI elements of navigation system 350 (e.g., Title 330 “Game Balance—Part 1” and a Week and Lesson information panel 340). Week and Lesson information panel 340 may be attached to item 310 and co-displayed in current item view 300. Week and Lesson information panel 340 may be a collapsible or detachable panel, which can be collapsed or detached from current item view 300 (e.g., to gain display space for item 310 on a small display screen such as of a tablet computer). For this purpose, Week and Lesson information panel 340 may include, for example, a user activable “collapsing” or slider UI element (e.g., UI element 351), which when activated collapses or detaches the panel from item 310.

Week and lesson information panel 340 may include information UIs (e.g., UI element 341, and UI element 342), which identify, for example, which week of the course and which lesson of the week is current (i.e. which week and lesson of the course current item 310 belongs to). UI element 341 and UI element 342 (as shown for in FIG. 3), respectively, may show, for example, that current item 310 belongs to “Week 3” of the course, and belongs to a lesson titled “Game Balance,” which is lesson 3 of 4 for the week. Week and Lesson information panel 340 may also include an information UI element (e.g., UI element 349), which provides information on the lesson that is next to the current lesson in the online education course. For example, UI element 349 (as shown in FIG. 3) may, for example, show that next lesson is “Project: Game design document.” Week and Lesson information panel 340 may further include a user-activable navigation UI element 343 that may be activated to take the student to the week overview page for the course. The week overview page (as discussed with reference to breadcrumb 346 in navigation system 250 above) may provide week level contextual information on the course content (e.g., the week syllabus).

Week and Lesson information panel 340 may further include UI information elements (e.g., UI elements 344, 345, 346, 347 and 348) that may provide information on items in the current lesson (i.e. lesson 3 of 4, “Game Balance”). UI elements 344, 345, 346, 347 and 348 (as shown for in FIG. 3), respectively, may show, for example, that items in the current lesson “Game Balance” include the items “Balancing Your Game,” “Game Balance—Part I,” “Game Balance—Part II,” “Mechanic Balance,” and “Quiz: Balance Quiz.” UI elements 344, 345, 346, 347 and 348 may include further information UIs (e.g., icons 344a, 345a, 346a, 347a and 348a, and UI elements 345b, 346b, 347b and 348b) that may provide additional information of the items in the current lesson. For example, icon 344a, which may be a document or book symbol, may indicate that item 344 “Balancing Your Game” is a reading segment. Icons 345a, 346a and 347a, which for example, may include video play buttons, may indicate that the corresponding items (e.g., items 345, 346 and 347, respectively) are lecture segments. UI elements 345b, 346b, and 347b may, for example, indicate that the corresponding lecture segments are 3 minutes, 7 minutes and 9 minutes long. UI element 348b may indicate, for example, that the corresponding quiz item 348 has five questions. Such detailed information may help or guide the student in planning or scheduling his or her future course activities. Knowing that an assessment event (e.g., a quiz or exam) is upcoming in the lesson (e.g., as shown by inclusion of quiz item 348 in Week and Lesson information panel 340) may allow the student to focus on the content of the lectures and feel prepared for the assessment.

In example implementations, UI elements 344, 345, 346, 347 and 348 elements and/or the corresponding UI elements (e.g., icons 344a, 345a, 346a, 347a and 348a, and UI elements 345b, 346b, 347b and 348b) may include activable navigation elements or links that can be activated to navigate to the respective item views in the lesson. For example, a student may click on icon 347a in current item view 300 to navigate to item 347 (e.g. item Lecture segment “Mechanical Balance”). It will be noted that item 347 is not adjacent to current item view 300/item 310/item 345 in the lesson. Yet navigation system 350 (unlike navigation 250) allows the student to navigate from current item view 300/item 310/item 345 to a non-adjacent item view in a single click operation (e.g., a single click on icon 347a).

Navigation system 350 may be configured so that the students can navigate to all other items in the lesson with a single click. Students may often “jump around” non-adjacent items, for example, to review content in the lesson before taking a quiz. Navigation system 350 may enable the students to do so without constantly having to return to the week overview page, which can be a jarring transition, especially in weeks with lots of content. Furthermore, as discussed with reference to navigation system 250 above, getting back to a student's current item views in the week may involve scrolling through items of a week to find or locate a desired item view. Navigation system 350 may avoid such difficulties by providing week and lesson information (e.g., in Week and Lesson information panel 340) in the current item view and enabling direct and immediate navigation to other item views in the lesson by a single click in Week and Lesson information panel 340.

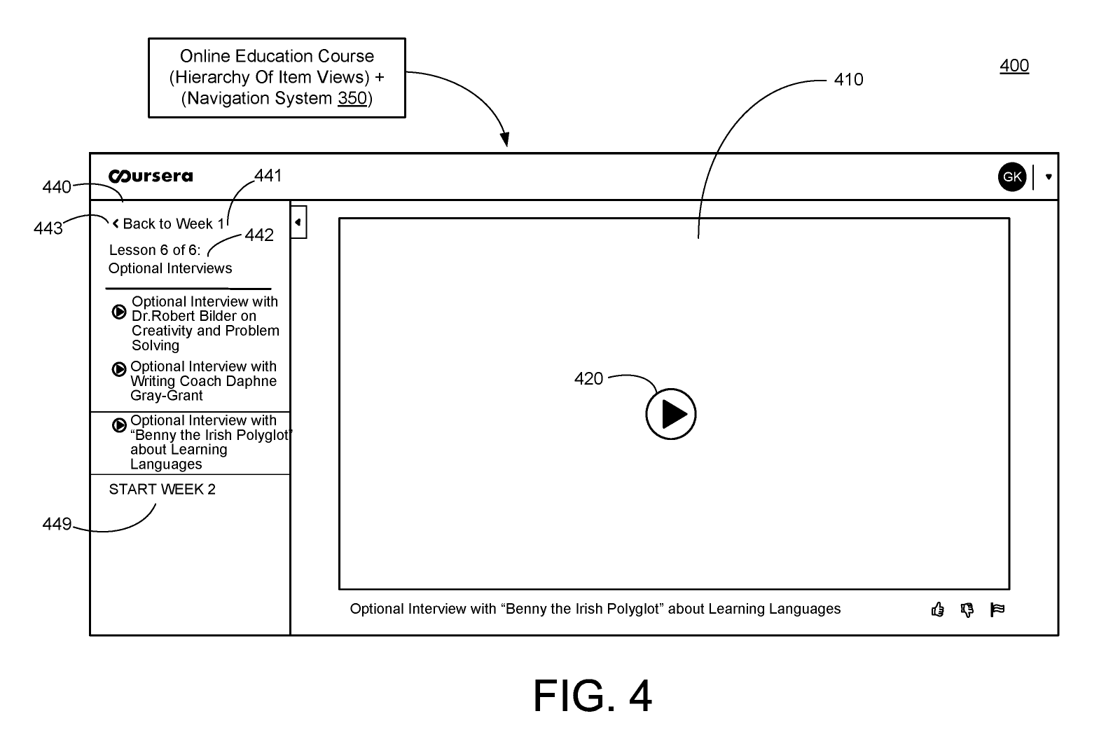

In some implementations, navigation system 350 may be configured to display clear demarcations or boundaries between weeks in the course content and to provide a specific activable UI element for transitioning to another week's course content from the current week. FIG. 4 is a screen shot of an example web page or item view 400 of an example online education course in which UI elements of navigation system 350 are incorporated. For example, item view 400 may include a lecture video item titled “Optional interview with ‘Benny the Irish Polygot’ about Learning Languages” (e.g., item 410), which the student can listen to or watch by activating, for example, a “play video” button 420 included in item 410.

Current item view 400 may include a Week and Lesson information panel 440 including information UIs (which may be similar to the UI elements of Week and Lesson information panel 340 discussed with reference to FIG. 3 above) of navigation system 350. Like Week and Lesson information panel 340, Week and Lesson information panel 440 may include UI elements (e.g., UI element 441, and UI element 442), which identify, for example, which week of the course and which lesson of the week is current (i.e., which week and lesson of the course, the current item 410 belongs to). Furthermore, like Week and Lesson information panel 340, Week and Lesson information panel 440 may include a user activable navigation UI element 443 that may be activated to trigger the display of the week overview page for the course. In addition, week and lesson information panel 440 may include a user activable navigation UI element 449, which may be configured to transition to another week's course content (e.g., Week 2) when explicitly activated by the student.

In further example implementations, navigation system 350 may also include UI elements configured to provide the student with completion or progress information at week, lesson or item levels of the course. In an example implementation, completion or progress information may be provided, for example, by using a color coding scheme to color UI elements corresponding to the week levels, lesson levels and item levels displayed, for example, in Week and Lesson information panel 340 or 440, or in the current item view displayed. Weeks, lesson or items that have been completed, may for example, be marked with a green color. Weeks, lesson or items that have not been completed, may for example, be marked with yellow color. In some implementations, progress bars may be displayed in the current item level view indicating the students' progress toward the week, lesson or item levels of the course.

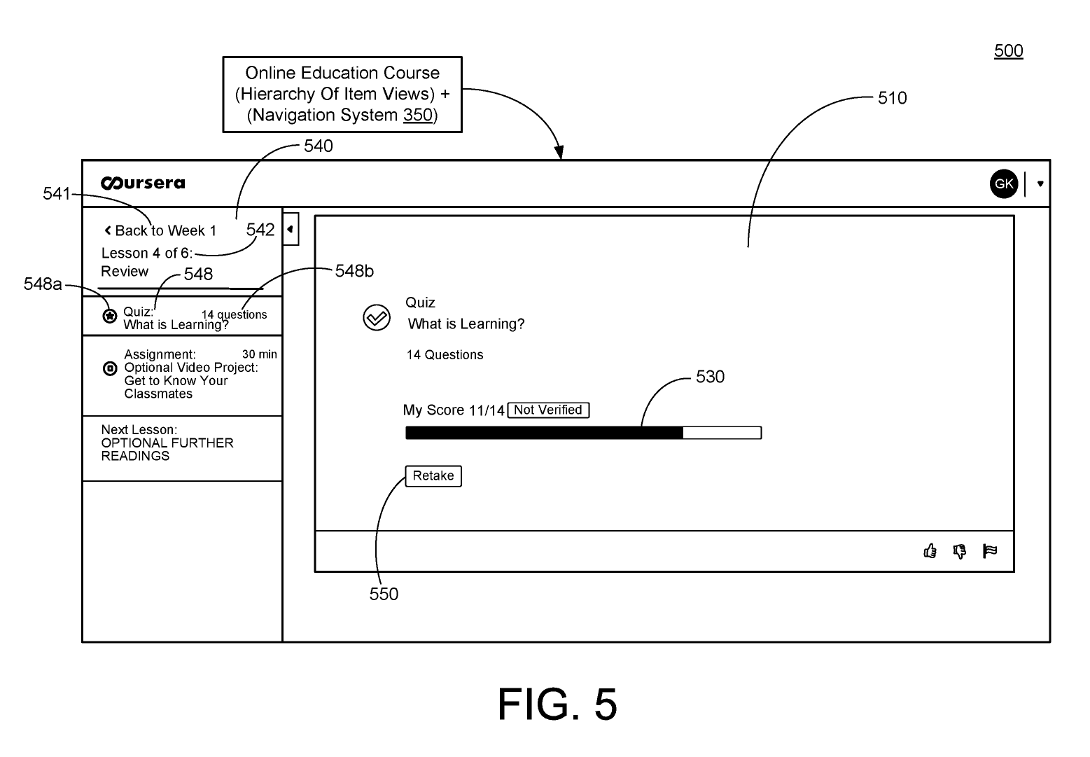

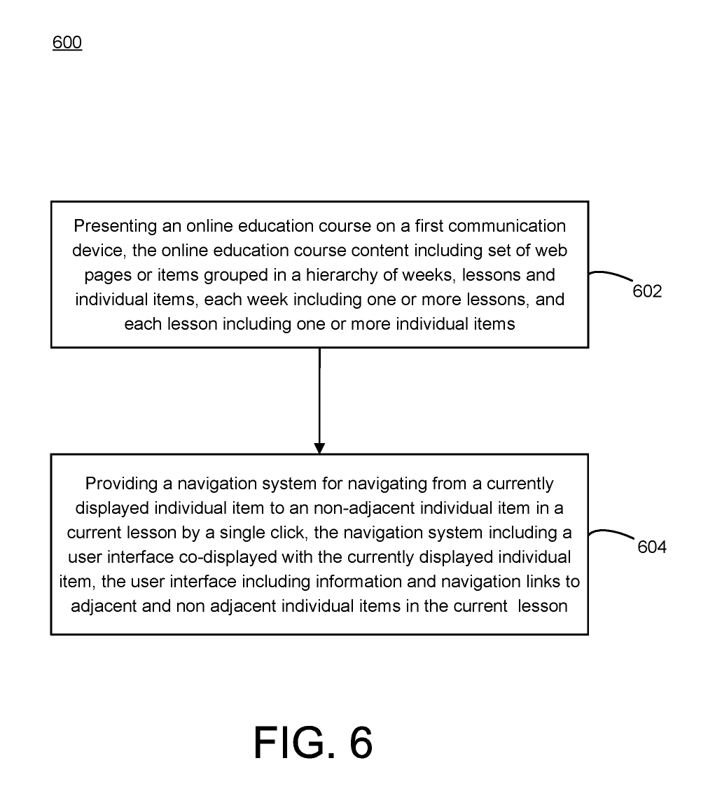

FIG. 5 is a screen shot of an example web page or item view 500 of an example online education course in which UI elements of navigation system 350 are incorporated. Item view 500 may include, for example, the item “Quiz: What is learning” (e.g., item 510). Current item view 500 may include a Week and Lesson information panel 540 including information UIs (which may be similar to the UI elements of Week and Lesson information panel 340 discussed with reference to FIG. 3) of navigation system 350. Like Week and Lesson information panel 340, Week and Lesson information panel 540 may include UI elements (e.g., UI element 541, and UI element 542), which identify, for example, which week of the course and which lesson of the week is current (i.e. which week and lesson of the course, current item 510 belongs to). Further, like Week and Lesson information panel 340, Week and Lesson information panel 540 may include UI elements that provide information on items in the current lesson (e.g., “Review”). For example, Week and Lesson information panel 540 may include UI elements 548a, 548 and 548b, which may display information (as shown in FIG. 5) related to the item “Quiz: What is Learning.” UI element 548b may show that there are 14 questions in the quiz. UI element 548a (like icon 348a, FIG. 3) may be an activable navigation element that can be activated to navigate to the corresponding item (e.g., “Quiz: What is Learning”) in the lesson. In the example shown in FIG. 5, UI element 548a may be colored green to indicate that the student has completed the quiz. Furthermore, in the example shown in FIG. 5, item 510 may include a progress bar showing student's progress (e.g., the number of correct answers to the 14 questions) in the completed quiz. Item 510 may further include an activable navigation element (e.g., UI element 550) that the student can activate to navigate to the quiz item again and retake the quiz.

While concepts of navigation systems have been described in the foregoing using example online education course structures having content organized as an a hierarchy: week/lessons/items, it will be understood that the same, or similar, concepts are also applicable to navigations systems for online education course structures having content organized differently (e.g., as a hierarchy: chapter/section/subsection/items, etc.). The online education course content may, for example, include discussion and review group or subgroup threads organized in a hierarchy.

It may be expected that the navigation systems for traversing online education course materials described herein (e.g., navigation system 350) may improve the quality or learning experience of a student by enabling navigation which enables chunking of the education course material in useful amounts (e.g., for providing explicit breakpoints for week-to-week or lesson-to-lesson transitions) and enable connection of new materials to learned materials. Students may know when a lesson/week in the online education course has ended and may be make a conscious decision to start the next lesson/week. Further, using navigation system 350 students may be able tell how far they have progressed in the current week without leaving the current item view. Students may see the time estimates for each item in the lesson without leaving the current item.

An example method 600 includes presenting an online education course on a first communication device, for example, to a student or learner (602). The online education course content may include a set of web pages or items grouped in a hierarchy, for example, a hierarchy of weeks, lessons and individual items. Each week may include one or more lessons, and each lesson may include one or more individual items.

Method 600 further includes providing a navigation system for navigating from a currently displayed individual item on a first communication device to another non-adjacent individual item in a current lesson by a single click operation (604). The navigation system includes a user interface co-displayed with the currently displayed individual item on the first communication device. The user interface may include contextual week and lesson information and navigation links to adjacent and non adjacent individual items in the current lesson.

The disclosed subject matter can be implemented in numerous ways, including as a process; an apparatus; a system; a computer program product embodied on a computer readable storage medium; and/or a processor, such as a processor configured to execute instructions stored on and/or provided by a memory coupled to the processor. These implementations, or any other form that the disclosed subject matter may take, may be referred to herein as techniques. In general, the order of the steps of disclosed processes may be altered within the scope of the disclosed subject matter. Unless stated otherwise, a component such as a processor or a memory described as being configured to perform a task may be implemented as a general component that is configured to perform the task at a given time or a specific component that is manufactured to perform the task. As used herein, the term “processor” refers to one or more devices, circuits, and/or processing cores configured to process data, such as computer program instructions. The processor may be a semiconductor-based processor.

The detailed description of one or more embodiments of the disclosed subject matter is provided above along with accompanying figures that illustrate the principles of the disclosed subject matter. The disclosed subject matter is described in connection with such embodiments, but the disclosed subject matter is not limited to any embodiment. The scope of the disclosed subject matter is limited only by the claims and the disclosed subject matter encompasses numerous alternatives, modifications and equivalents. Numerous specific details are set forth in the foregoing description in order to provide a thorough understanding of the disclosed subject matter. These details are provided for the purpose of example and the disclosed subject matter may be practiced according to the claims without some or all of these specific details. For the purpose of clarity, technical material that is known in the technical fields related to the disclosed subject matter has not been described in detail so that the disclosed subject matter is not unnecessarily obscured.

While certain features of the described embodiments and implementations have been described herein, many modifications, substitutions, changes and equivalents will now occur to those skilled in the art. It is, therefore, to be understood that the appended claims are intended to cover all such modifications and changes as fall within the scope of the described embodiments and implementations.

What is claimed is:

1. A system for navigating an online education course presentation on a client device, the online education course having a hierarchical schema of items grouped in one or more hierarchy levels and presented as web pages or item views on the client device, the system comprising:
one or more processors; and
one or memories storing computer-readable instructions that when executed by the one or more processors
display, to a learner, a plurality of user interface (UI) elements integrated with a current item view of the online education course presentation, the plurality of UI elements including:
at least one UI element that provides visual information about the current item view and its location in the hierarchical schema of the online education course; and
at least one UI element that leads to a different item view from the current item view of the online education course presentation.

2. The system of claim 1, wherein the at least one UI element that provides visual information about the current item view and its location in the hierarchical schema of the online education course is an UI element that shows an analog measure of progress represented by the current item view in the online education course.

3. The system of claim 1, wherein the at least one UI element that provides visual information about the current item view and its location in the hierarchical schema of the online education course is a breadcrumb UI element that shows a URL trail leading to the current item view in the hierarchical schema of the online education course.

4. The system of claim 1, wherein the at least one UI element that leads to different item view from the current item view of the online education course presentation is an UI element that leads to an item view which is immediately adjacent to the current item view in the hierarchical schema of the online education course.

5. The system of claim 1, wherein the at least one UI element that leads to different item view from the current item view of the online education course presentation is an UI element that leads, in a single click operation, to an item view which is not immediately adjacent to the current item view in the hierarchical schema of the online education course.

6. The system of claim 1, wherein the online education course has an overview page for a hierarchy level in the hierarchical schema of the online education course, and wherein the at least one UI element that leads to a different item view from the current item view of the online education course presentation is an UI element that leads to the overview page for the hierarchy level in the hierarchical schema of the online education course.

7. The system of claim 6, wherein the overview page for the hierarchy level in the hierarchical schema of the online education course provides contextual information for the current item view of the online education course presentation.

8. The system of claim 1, wherein the plurality of user interface elements integrated with a current item view of the online education course presentation include one or more UI elements disposed in an informational panel co-displayed with the current item view.

9. The system of claim 8, wherein the one or more UI elements disposed in the informational panel co-displayed with the current item view include one or more UI elements that provide contextual information for the current item view of the online education course presentation at one or more of the hierarchy levels in the hierarchical schema of the online education course.

10. The system of claim 9, wherein the online education course includes an overview page for an hierarchy level in the hierarchical schema of the online education course, and wherein the one or more UI elements disposed in the informational panel co-displayed with the current item view include an UI element that leads to the overview page for the hierarchy level in the hierarchical schema of the online education course.

11. The system of claim 8, wherein the current item view relates to an item in one hierarchy level in the hierarchical schema of the online education course, and wherein the one or more UI elements disposed in the informational panel co-displayed with the current item view include an UI element that leads, in a single click operation, to an item view related to an item in another hierarchy level in the hierarchical schema of the online education course.

12. The system of claim 8, wherein the current item view relates to an item in one hierarchy level in the hierarchical schema of the online education course, and wherein the one or more UI elements disposed in the informational panel co-displayed with the current item view include an UI element that leads, in a single click operation, to an item view related to another item in the same hierarchy level as the current item view.

13. The system of claim 8, wherein the one or more UI elements disposed in the informational panel co-displayed with the current item view include one or more UI elements that provide completion or progress information for the one or more hierarchy levels in the hierarchical schema of the online education course.

14. The system of claim 8, wherein the informational panel co-displayed with the current item view includes a user-activable UI element which when activated collapses or detaches the informational panel from the current item view.

15. The system of claim 1, wherein the current item view includes an UI element leading to a quiz on materials in the online education course, and wherein the at least one UI element that leads to a different item view from the current item view of the online education course presentation is an UI element that leads to an item view related to review materials in the online education course for the quiz.

16. A method, comprising:
presenting an online education course on a first communication device, the online education course presentation having a hierarchical schema of items grouped in one or more hierarchy levels and presented as web pages or item views on the first communication device; and
integrating a navigation system with a current item view of the online education course presentation, the navigation system including at least one UI element that provides visual information about the current item view and its location in the hierarchical schema of the online education course, and at least one UI element that leads to a different item view from the current item view of the online education course presentation.

17. The method of claim 16, wherein the at least one UI element that provides visual information about the current item view and its location in the hierarchical schema of the online education course is an UI element that shows an analog measure of progress represented by the current item view in the online education course.

18. The method of claim 16, wherein the at least one UI element that provides visual information about the current item view and its location in the hierarchical schema of the online education course is a breadcrumb UI element that shows a URL trail leading to the current item view in the hierarchical schema of the online education course.

19. The method of claim 16, wherein the at least one UI element that leads to different item view from the current item view of the online education course presentation is an UI element that leads to an item view which is immediately adjacent to the current item view in the hierarchical schema of the online education course.

20. The method of claim 16, wherein the at least one UI element that leads to different item view from the current item view of the online education course presentation is an UI element that leads, in a single click operation, to an item view which is not immediately adjacent to the current item view in the hierarchical schema of the online education course.

21. The method of claim 16, wherein the online education course includes an overview page for a hierarchy level in the hierarchical schema of the online education course, and wherein the at least one UI element that leads to a different item view from the current item view of the online education course presentation is an UI element that leads to the overview page for the hierarchy level in the hierarchical schema of the online education course.

22. The method of claim 21, wherein the overview page for the hierarchy level in the hierarchical schema of the online education course provides contextual information for the current item view of the online education course presentation.

23. The method of claim 16, wherein the plurality of user interface elements integrated with a current item view of the online education course presentation include one or more UI elements disposed in an informational panel co-displayed with the current item view.

24. The method of claim 23, wherein the one or more UI elements disposed in the informational panel co-displayed with the current item view include one or more UI elements that provide contextual information for the current item view of the online education course presentation at one or more of the hierarchy levels in the hierarchical schema of the online education course.

25. The method of claim 24, wherein the online education course includes an overview page for an hierarchy level in the hierarchical schema of the online education course, and wherein the one or more UI elements disposed in the informational panel co-displayed with the current item view include an UI element that leads to the overview page for the hierarchy level in the hierarchical schema of the online education course.

26. The method of claim 23, wherein the current item view relates to an item in one hierarchy level in the hierarchical schema of the online education course, and wherein the one or more UI elements disposed in the informational panel co-displayed with the current item view include an UI element that leads, in a single click operation, to an item view related to an item in another hierarchy level in the hierarchical schema of the online education course.

27. The method of claim 23, wherein the current item view relates to an item in one hierarchy level in the hierarchical schema of the online education course, and wherein the one or more UI elements disposed in the informational panel co-displayed with the current item view include an UI element that leads, in a single click operation, to an item view related to another item in the same hierarchy level as the current item view.

28. The method of claim 23, wherein the one or more UI elements disposed in the informational panel co-displayed with the current item view include one or more UI elements that provide completion or progress information for the one or more hierarchy levels in the hierarchical schema of the online education course.

29. The method of claim 23, wherein the informational panel co-displayed with the current item view includes a user-activable UI element which when activated collapses or detaches the informational panel from the current item view.

30. The method of claim 16, wherein the current item view includes an UI element leading to a quiz on materials in the online education course; and wherein the at least one UI element that leads to a different item view from the current item view of the online education course presentation is an UI element that leads to an item view related to review materials in the online education course for the quiz.
